(19) United States
(12) Patent Application Publication
(10) Pub. No.: US 2012/0062602 A1
(43) Pub. Date: Mar. 15, 2012

(54) METHOD AND APPARATUS FOR RENDERING A CONTENT DISPLAY

(75) Inventors: Chirag Jayantilal Vadhavana, Berlin (DE); Thomas Hütter, Berlin (DE); Mark Schlusnus, Berlin (DE)

(73) Assignee: Nokia Corporation, Espoo (FI)

(21) Appl. No.: 13/221,509

(22) Filed: Aug. 30, 2011

Related U.S. Application Data
(60) Provisional application No. 61/382,200, filed on Sep. 13, 2010.

(51) Int. Cl. G09G 5/00

(52) U.S. Cl. 345/676; 345/672

(57) ABSTRACT

An approach is provided for customizing map presentations based on mode of transport. A map customizing platform determines a mode of transport with respect to a mapping service. The map customizing platform then selects one or more characteristics for rendering a map display of the mapping service based, at least in part, on the mode of transport and causes, at least in part, rendering of the map display based, at least in part, on the characteristics.

### RELATED APPLICATIONS

This application claims the benefit of the earlier filing date under 35 U.S.C. §119(e) of U.S. Provisional Application Ser. No. 61/382,200 filed Sep. 13, 2010, entitled “Method and Apparatus for Rendering a Content Display,” the entirety of which is incorporated herein by reference.

### BACKGROUND

Service providers (e.g., wireless and cellular services) and device manufacturers are continually challenged to deliver value and convenience to consumers by, for example, providing compelling network services and advancing the underlying technologies. One area of interest has been the development of services and technologies for generating and/or customizing data that is presented to users, such as the content displays presented by mapping services and other services that depend on maps (e.g., navigation services). More specifically, electronic mapping services have access to vast stores of detailed information related a variety of map elements (e.g., roads, points of interest, buildings, parks, tourist attractions, etc.) that can be rendered in a map display. In fact, the number of map elements and related information available for display often greatly exceeds (1) the display area of the device presenting the map-related service, and/or (2) the resources of the device available for rendering the display, particularly when the device is a mobile device (e.g., a smartphone) with limited resources (e.g., computing resources, memory, bandwidth, etc.). Moreover, because the content often exceeds the available display area, users frequently move or pan the display area over the content. This movement can further tax the limited resources of the device presenting the content. Accordingly, service providers and device manufacturers face significant technical challenges to enabling to presentation of potentially complex content displays (e.g., mapping displays) while maintaining an acceptable level of performance (e.g., responsiveness, smoothness, etc.).

### Some Example Embodiments

Therefore, there is a need for an approach for efficiently rendering a content display in a resource constrained environment.

According to one embodiment, a method comprises receiving an input for specifying a movement of a viewport over content rendered for display at a device. The method also comprises determining a first rendering technique for at least a first portion of the movement. The method further comprises determining a second rendering technique for at least a second portion of the movement.

According to another embodiment, an apparatus comprising at least one processor, and at least one memory including computer program code for one or more programs, the at least one memory and the computer program code configured to, with the at least one processor, cause the apparatus to receive an input for specifying a movement of a viewport over content rendered for display at a device. The apparatus is also caused to determine a first rendering technique for at least a first portion of the movement. The apparatus is further caused to determine a second rendering technique for at least a second portion of the movement.

According to another embodiment, a computer-readable storage medium carrying one or more sequences of one or more instructions which, when executed by one or more processors, cause an apparatus to receive an input for specifying a movement of a viewport over content rendered for display at a device. The apparatus is also caused to determine a first rendering technique for at least a first portion of the movement. The apparatus is further caused to determine a second rendering technique for at least a second portion of the movement.

According to another embodiment, an apparatus comprises means for receiving an input for specifying a movement of a viewport over content rendered for display at a device. The apparatus also comprises means for determining a first rendering technique for at least a first portion of the movement. The apparatus further comprises means for determining a second rendering technique for at least a second portion of the movement.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of rendering a content display, according to one embodiment;

FIG. 2 is a diagram of the components of a rendering module, according to one embodiment;

FIG. 3 is a flowchart of a process for rendering a content display, according to one embodiment;

FIGS. 4A-4C are diagrams of user interfaces for utilizing the process of FIG. 3, according to various embodiment;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., a handset) that can be used to implement an embodiment of the invention.

### DESCRIPTION OF SOME EMBODIMENTS

A method and apparatus for rendering a content display are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are primarily described with respect to a content display generated by a mapping service (e.g., a map or navigation display), it is contemplated that the approach described herein may be used with any other type of graphically intensive content displays and/or corresponding services that consume significant amounts of device resources. By way of example, these other content displays and/or services may include browser displays, image viewing and/or processing displays, virtual reality displays, and the like.

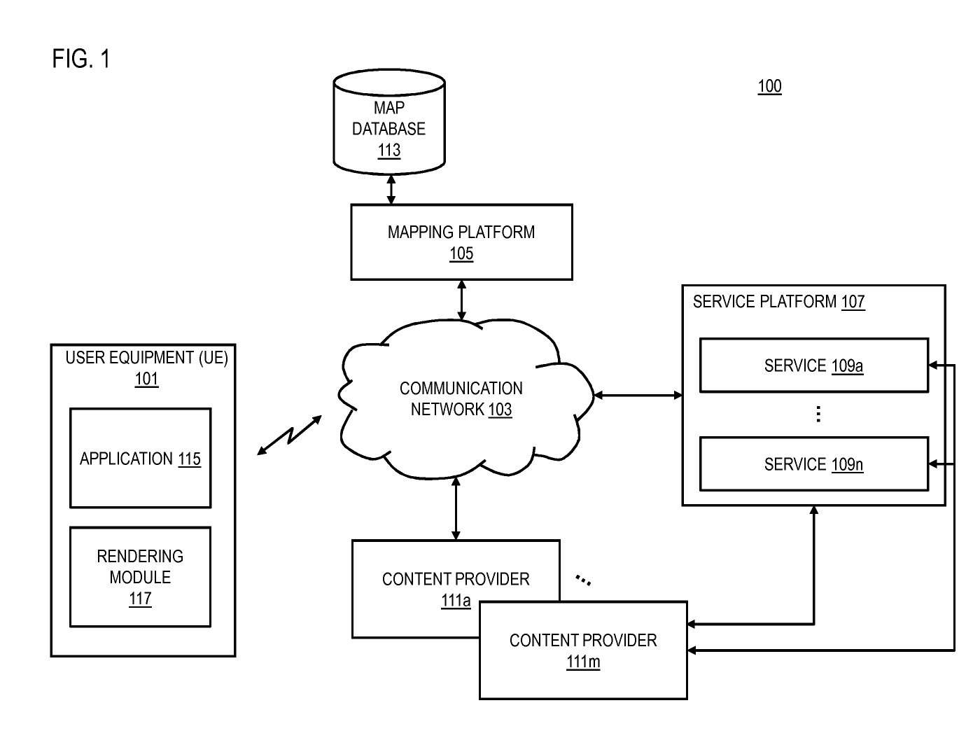

FIG. 1 is a diagram of a system capable of rendering a content display, according to one embodiment. For many applications (e.g., mapping applications), an important factor for user acceptance is the responsiveness of the user interface and associated content display. For example, in a mapping application, users prefer or otherwise expect a content display (e.g., a map display) that provides for smooth and responsive panning. However, in many cases, every move of a content display such as a map display can involve a potentially resource intensive rendering process. More specifically, to render the movement of the content display, the application typically goes through stages of preparing one or more frames of the content and then displaying the frames to animate the movement or panning over the content. In one embodiment of a mapping service, the frame preparation process can generally involve reading map data, decoding the map data, and then rendering the map data according to parameters (e.g., location, zoom, level of detail, visual characteristics, etc.) specified by the mapping service and/or its client application. This process can be quite time and resource (e.g., computation resources, bandwidth, memory, etc.) intensive.

By way of example, in a typical modern mobile device (e.g., smartphone), rendering of each frame can take between approximately 30 ms to 200 ms depending the execution context of the device. In one embodiment, the execution context depends on a varying number of factors spanning across the software state and/or the operating system state of the device. As used herein, the software state refers to the amount of effort the software of a device spends on preparing or generating requested frames of the content display. The effort depends, for instance, on whether the content data is available locally (e.g., a cache) or remotely (e.g., at a network storage), how much of the content data is to be decoded, scheduling of other parallel activities within the software, etc. The operating system state refers to the amount of effort the operating system spends to help the software prepare the requested frames. For example, the operating system can assist the software by providing files system access to map data, providing network access functions, etc. The effort by the operating system can further depend on parallel loads from other concurrent applications or services, as well as on network or file system congestion. In either case, the efforts spent the by software and the operating system affect the preparation time for each frame. Moreover, because the efforts or loads can vary considerably depending on what other processes are executing on the same device, the rate of rendering can be unpredictable, thereby potentially reducing the smoothness or responsiveness of the content display.

One traditional technique for rendering a content display is termed New Frame per Move (NFM) wherein a new frame is prepared and rendered for every movement. The NFM technique provides for smooth movement or panning of the content display because a display frame is generally rendered for each detected movement. However, depending on the execution context and corresponding efforts by the software and operating system, the device may not be able to render all the frames concurrently with the movement. In this case, the NFM technique can result in a lag between the rendered movement of the content display and the actual specified movement, thereby creating a less responsive user experience. The lag can be particularly noticeable when the user provides input for the panning or movement via a touch screen-enabled device. For example, if the rendering of the content display cannot keep pace with the movement of the user's finger on the touch screen, the user is likely to perceive the lack of responsiveness.

Another traditional technique termed Bitmap Move/Image Move (BM/IM) increase responsiveness by avoiding frame preparation for each detected movement. Instead, BM/IM prepares one frame that is typically the size of the device's display area or larger. This frame is then simply moved around the display in response to movement inputs. The next frame is prepared only when a suitable state is reached (e.g., when the movement input stops, when the movement extends beyond a predetermined distance from the displayed frame, etc.). However, the problem with this approach is that empty areas or tiles are seen when the content is moved or panned beyond the pre-pared frame's extent.

To address these problems and shortcomings of the traditional approaches described above, a system 100 of FIG. 1 introduces to the capability to (1) receive an input for specifying movement of a viewport over content rendered for displayed at a device, (2) determine a first rendering technique for at least a first portion of the movement, and (3) determine a second rendering technique for at least a second portion of the movement. As used herein, the term “viewport” refers to a displayable portion of the content that corresponds to the displayable area of a device. Typically, the content (e.g., a mapping data) selected for display is larger than displayable area so that the user can move or pan the viewport over the content to bring different portions of the content into view of the display area or screen.

In the approach described herein, the system 100 enables the determination, selection, and/or use of multiple rendering techniques for a movement of the content display to provide the “perceived” appearance of smoothness and/or responsiveness while operating in a device environment with constrained resources. In other words, depending on the context of the movement, the system 100 selects from among multiple rendering techniques to achieve a balance between smoothness and responsiveness/speed of rendering.

In one embodiment, the movement is provided via a touch-enabled interface whereby a user performs a touch gesture (e.g., a swipe) on the screen to indicate a particular movement or panning of the content display. In this case, the movement can be divided into at least two portions. A first portion of the movement can include the period during which the user's finger is in contact with the touch screen. Then, a second portion of the movement can the period in which the gesture is substantially completed and the user's finger is no longer in contact with the touch screen, but a kinetic follow-up or inertial scrolling effect continues the movement for a specific duration and/or distance. In addition or alternatively, it is also contemplated that the gesture and corresponding kinetic follow-up may also be indicated by a cursor movement, mouse movement, trackball movement, and other like input device.

In one embodiment, the system 100 selects a rendering technique that prioritizes speed or responsiveness during the first portion of the movement where the finger (or other input device) is directly tracking on the touch-screen. In other words, the system 100 determines a rendering technique that prioritizes tracking or following the user's finger over smooth movement. A pan movement that manages to catch up with or more closely track the user finger is generally perceived as acceptably smooth, even though the rendering technique might skip or jump between consecutive frames to keep up with the finger. As noted above, a pan movement that is smooth but consistently and noticeably lags behind the user's finger is perceived as slow or unresponsive. By way of example, a rendering technique selected for the first portion may still have a frame preparation stage for every move, but the time lost in frame preparation can be compensated by ensuring that the next frame to be prepare and rendered has maximum proximity to the user's current passion and not to the last frame drawn.

Then for the second portion of the movement (e.g., the kinetic or inertial follow-up portion), the system 100 can reverse the prioritization by favoring smoothness. In the second portion of the movement, the user's finger is no longer on the touch-screen and need not be tracked. Accordingly, the system 100 selects a rendering technique that minimizes the gaps between frames to achieve more smoothness in the movement. In this way, the approach of the system 100 advantageously improves the perceived smoothness of panning by dynamically selecting from among multiple rendering techniques (and corresponding priorities of speed versus smoothness) based, at least in part, on the movement of the content display and/or the gesture specifying the movement.

In another embodiment, the system 100 can determine the execution context of the device and estimate an expected time for preparing each frame. The determining of the rendering techniques to user can then be further based on this estimate. For example, if the estimated frame preparation time is relatively low (e.g., each frame can be prepared and rendered relatively quickly on the order of approximately 30 ms), the selected rendering techniques include more features to improve smoothness of rendering. On the contrary, if the estimated frame preparation time is relatively high (e.g., approximately 200 ms), the disparity in prioritization of speed versus smoothness can be more pronounced between the rendering technique selected for the first portion and the rendering technique selected for the second portion.

In yet another embodiment, when the content display is, for instance, a map display, the system 100 can estimate the frame preparation time to include additional steps specific to functions related to generating the content or map display. By way of example, these functions include reading or otherwise obtaining the content data (e.g., map data) from a storage component (e.g., a local storage, network storage, or combination thereof), decoding the data to a form appropriate for the rendering engine, and the like.

As shown in FIG. 1, a user equipment (UE) 101 has connectivity over the communication network 103 to various content sources and/or services for rendering a content display at the UE 101. By way of example, the content sources and/or services include a mapping platform 105, a service platform 107 hosting one or more respective services 109a-109n, and content providers 111a-111m. In one embodiment, the mapping platform 105 has connectivity to a map database 113 for storing map data for generating a map display at, for instance, a client application 115. In certain embodiments, the mapping information and the maps presented to the user may be an augmented reality view, a simulated 3D environment, a 2D map, or the like. By way of example, the map display is rendered using a vector-based rendering engine to facilitate dynamic manipulation of the rendering characteristics of the vector-based mapping models. It is also contemplated that the mapping platform 103 may pre-render the vector-based maps as tiles (e.g., bitmapped sections of the map display) to maintain compatibility with tile-based rendering applications and/or reduce the processing burden on the application 115 for rendering vector-based maps. The application 115 further supports user panning or movement over the map display via, for instance, touch input, cursor input, pointing device, etc.

In other embodiments, the simulated 3D environment is a 3D model created to approximate the locations of streets, buildings, features, etc. of an area. This model can then be used to render the location from virtually any angle or perspective for display on the UE 101. In some use cases, the 3D model or environment enables, for instance, the application 115 to animate movement through the 3D environment to provide a more dynamic and potentially more useful or interesting mapping display to the user. In one embodiment, structures are stored (e.g., in the map database 113) using simple objects (e.g., three dimensional models describing the dimensions of the structures). Further, more complex objects may be utilized to represent structures and other objects within the 3D representation. Complex objects may include multiple smaller or simple objects dividing the complex objects into portions or elements. To create the 3D model, object information can be collected from various databases as well as data entry methods such as processing images associated with location stamps to determine structures and other objects in the 3D model.

In another embodiment, the mapping platform 103 can obtain content information (e.g., media files) and/or context information for rendering the map display. By way of example, the content and/or context information include one or more identifiers, data, metadata, access addresses (e.g., network address such as a Uniform Resource Locator (URL) or an Internet Protocol (IP) address; or a local address such as a file or storage location in a memory of the UE 101), description, or the like associated with the content and/or context. The content, for instance, includes live media (e.g., streaming broadcasts), stored media (e.g., stored on a network or locally), metadata associated with media, text information, location information of other user devices, mapping data, geo-tagged data (e.g., indicating locations of people, objects, images, points-of-interest, etc.), or a combination thereof. In some embodiments, the content may be provided by the service platform 107, the one or more services 109a-109n (e.g., music service, video service, social networking service, content broadcasting service, etc.), the one or more content providers 115a-115m (e.g., online content retailers, public databases, etc.), and/or other content source available or accessible over the communication network 103. It is contemplated that the mapping platform 103, the service platform 111, and/or the content provider 115 can be implemented, for instance, via shared or partially shared hardware equipment or different hardware equipment.

In another embodiment, the application 115 may be a client application of the service platform 107, the services 109a-109n, and/or the content providers 111a-111m that can render or generate a display based on the content received from the service platform 107, the services 109a-109n, and/or the content providers 111a-111m. By way of example, the content is delivered from the content providers 111a-111m to the UE 101 through the service platform 107 and/or the services 109a-109n. For example, a service 109a (e.g., an imaging service) may obtain content (e.g., image data) from a content provider 115a to deliver imaging-related services to the UE 101.

In yet another embodiment, the application 115 (e.g., a camera application) may generate or otherwise obtain content directly. For example, the application 115 may capture an image for presentation or display at the device.

As shown in FIG. 1, the UE 101 includes a rendering module 117 for rendering content data associated with the application 115 according to the approach described herein. In one embodiment, the rendering module 117 is an independent module resident in the UE 101 as a software component, operating system component, or a combination thereof. It is also contemplated that the rendering module 117 may be incorporated within the application 115 or another application executing on the UE 101.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the mapping platform 103, the service platform 107, there services 109a-109n, and the content providers 111a-111m communicate with each other and other components of the communication network 103 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the application 115 and the corresponding mapping platform 105, service platform 107, services 109a-109n, the content providers 111a-111m, or a combination thereof interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

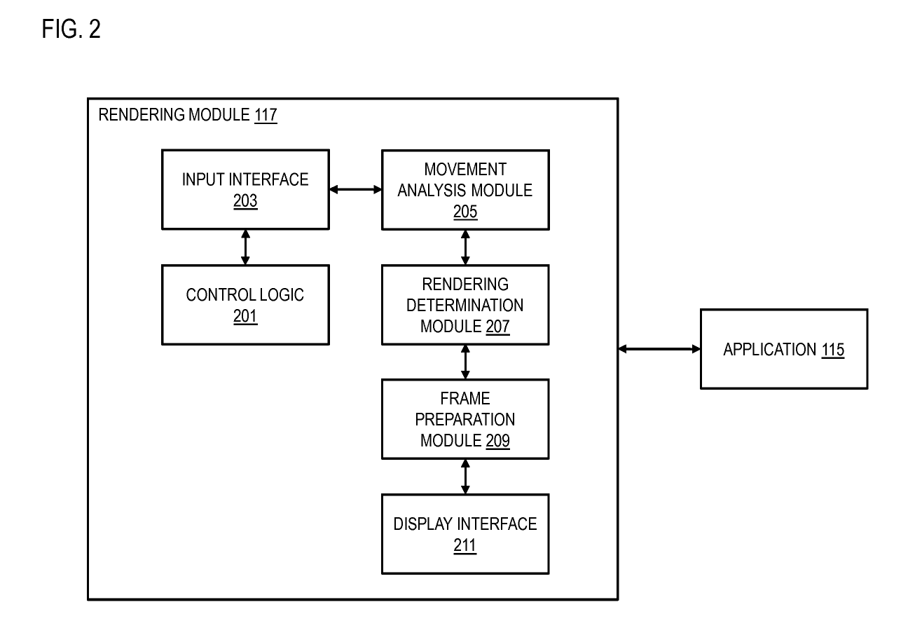

FIG. 2 is a diagram of the components of the rendering module, according to one embodiment. By way of example, the rendering module 117 includes one or more components for determining a plurality of rendering techniques for moving or panning a viewport over a content display. It is contemplated that the functions of these components may be combined in one or more components or performed by other components of equivalent functionality. In this embodiment, the rendering module 103 includes at least a control logic 201 which executes at least one algorithm for executing functions of the rendering module 117. In one embodiment, the control logic 201 interacts with an input interface 203 to receive or otherwise detect an input for specifying movement (e.g., panning) of a content display (e.g., a mapping display). By way of example, the input interface 203 may communicate with an input/output control component of the UE 101. Such an input/output control component may have control of over touch-screen hardware or other input device (e.g., keyboard, track pad, pointer, directional pad, accelerometer, gyroscope, etc.) of the UE 101. In this way, the input/output control component may detect and then relay data from the input device(s) to the input interface 203. For example, if a user provides input via the touch screen, the input/output control component detects the position of the user's finger on the touch screen and provides the input data to the rendering module 117 through the input interface 203.

On receiving the input data, the input interface 203 provides the data to the movement analysis module 205. The movement analysis module 205, in turn, processes the input data to determine whether the data is for specifying a movement of the viewport over the content display. For example, the movement analysis module 205 can determine whether the input data corresponds to a gesture (e.g., a swipe or other like motion) that represents a command to move the viewport. If such a gesture if found, the movement analysis module 205 can then translate the gesture into a corresponding movement of the viewport. More specifically, the movement analysis module 205 can determine, for instance, a distance, velocity, trajectory, acceleration, or other movement characteristic that should be applied to movement of the viewport based on the input data. In addition, the movement analysis module 105 can determine specific sequences of the gesture (e.g., a portion of the swipe in which the user's finger is in direct contact with the touch screen surface, and then a kinetic follow-up portion based on the movement characteristics determined during the first portion of the gesture). For example, the movement analysis module 205 can analyze input data associated with a flick or swipe gesture to determine that the gesture results in two movement sequences or portions: (1) moving the viewport based on movement of the user's finger when in direct contact with the touch screen; and (2) moving the viewport for a distance after the user's finger is no longer in contact with the touch screen to represent the kinetic or inertial follow-up to the first portion of the movement.

The rendering determination module 207 then determines one or more rendering techniques appropriate for the respective portions of the movement. For example, as described above, the create perceived smoothness, the rendering determination module 207 may determine or select a rendering technique that prioritizes speed or responsiveness (e.g., an ability to keep up with the movement of the user's finger when the finger is in contact with the touch screen) over smoothness (e.g., minimizing the gaps or distance between frames so that the movement is not jerky).

In one embodiment, the rendering determination module 207 can evaluate the execution context of the UE 101 (e.g., the amount of resources currently being consumed by the software and operating system components of the UE 101) to determine which rendering techniques to use. For instance, if there are sufficient resources to maintain a desired number of frames per second which accurately tracking user movement, the rendering determination module 207 may employ more smoothly performing algorithms (e.g., algorithms that base subsequent frames on a maximum distance between the frames). If the converse is true, the rendering determination module 207 may employ rendering algorithms prioritized for speed (e.g., algorithms that enable skipping frames).

In another embodiment, the rendering determining module 207 may apply a fixed rule or policy for determining rendering techniques and need not evaluate the execution context of the UE 101. For example, if the UE 101 is resource constrained (e.g., a traditional smartphone), the rendering determination module 207 can define a policy to always prioritize speed over smoothness during portions of the movement corresponding to direct user contact and then prioritize smoothness over speed during the kinetic or inertial follow-up portion of the movement.

The rendering determination module 207 then interacts with the frame preparation module 209 to prepare the frame based on the content provided by the application 115. In one embodiment, the frame preparation module 209 prepares the frames according to the rendering techniques determined or selected by the rendering determination module 207. For example, to prepare frames based on prioritizing speed or responsiveness, the frame preparation module 209 generates a first frame as based on a detected or reported position of the user's finger. After preparing the frame (which can often require up to approximately 200 ms to prepare), the frame preparation module 209 requests the latest position of the user's finger and then proceeds to generate the next frame based on the user's finger latest position. In some cases, this process results in skipping frames or otherwise generating frames with potentially significant gaps or distances between the frames. As noted previously, although skipping frames can result in more jerky motion, a typical user would instead have a perception of better smoothness because the frame preparation module 209 is able to keep up with the movement of the finger.

However, once the user's finger is no longer in contact with the touch screen, the frame preparation 209 can instead prioritize smoothness over speed. Again by shifting to a smoothness priority when the input gesture is substantially complete, the user will perceive a greater overall level of smoothness. In this case, the rendering technique controls the gaps or distances between the frames so that the gaps are below a threshold value. This value is set, for instance, so that the gaps between frames are small enough to be perceived as smooth motion between the frames.

By way of example, the frame preparation module 209 can perform calculations to determine the gaps between frames to achieve a desired smoothness. In one embodiment, the frame preparation module 209 calculates a velocity of the kinetic follow-up at a time “t” according the equation v(t)=1/t. This velocity is used to find the distance “d”, which is then integrated over the range between the velocity when the last prepared frame was rendered and the current calculated velocity of the user's finger on the touch screen. The magnitude of “d” depends on, for instance, the execution context or resource load on the UE 101. If “d” is a high value, there are greater gaps or jumps between frames. In this case, the “d” between consecutive frames can be controlled to ensure that the kinetic follow-up is a smooth movement.

Once one or more of the frames are prepared, the frame preparation module 209 forwards the frames to the display interface 211 for rendering at the UE 101. In one embodiment, the display interface 211 serves as a conduit between the rendering module 117 and the display hardware of the UE 101. In another embodiment, the display interface 211 is the conduit to convey the frames from the rendering module 117 back to the application 115. The application 115 is then responsible for initiating the display of the frames at the UE 101.

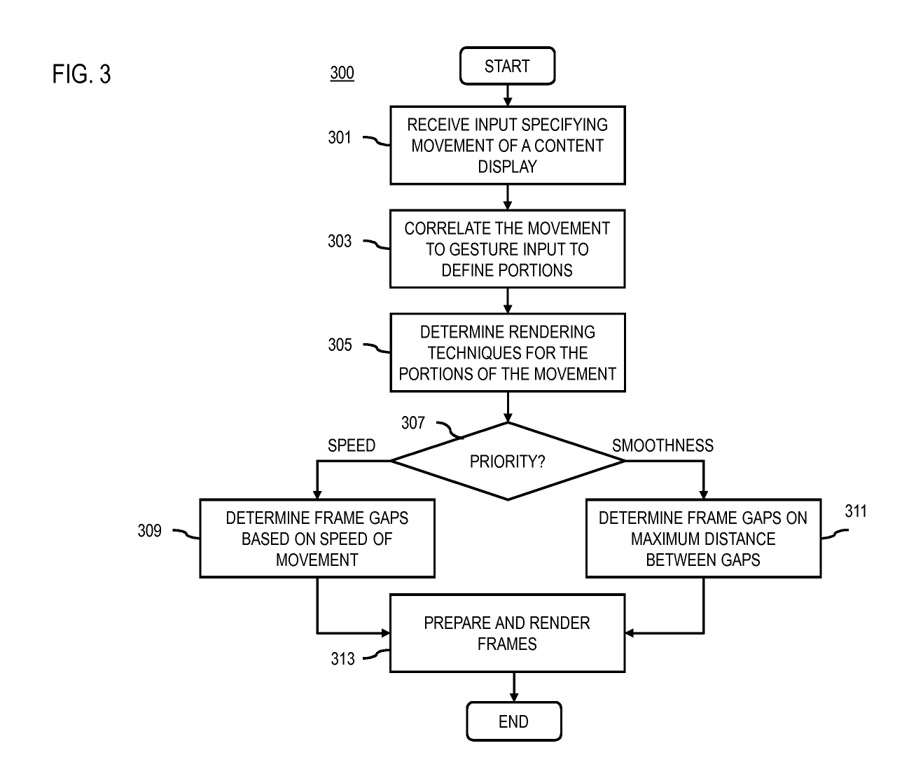

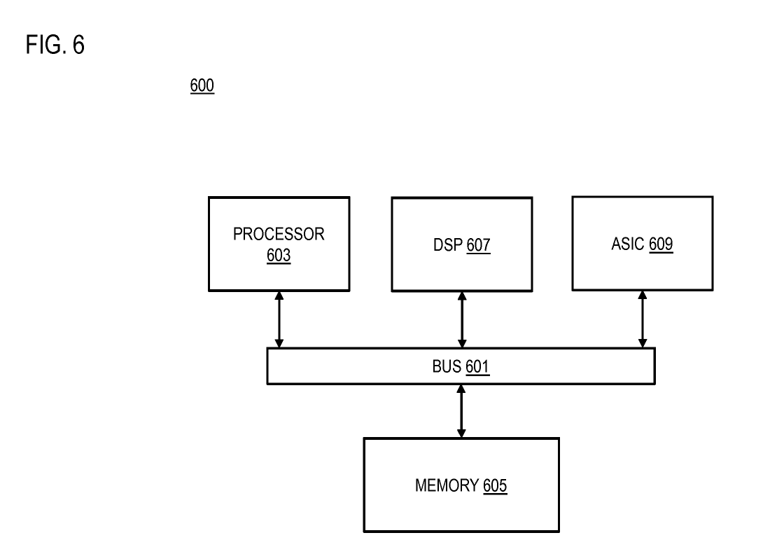

FIG. 3 is a flowchart of a process for rendering a content display, according to one embodiment. In one embodiment, the rendering module 117 performs the process 300 and is implemented in, for instance, a chip set including a processor and a memory as shown FIG. 6. In step 301, the rendering module 117 receives an input for specifying a movement of a viewport over content rendered for display at a device. As noted previously, in one sample use case, the content that is display is mapping information provided by, for the instance, the mapping platform 105. It is noted that mapping content is particularly challenging for a UE 101 with constrained resources to render smoothly because of the resource intensive processes associated with converting mapping data in to a visual display. For example, vector-based mapping data often are decoded and processed to convert the vectors to a traditional bitmap display.

In step 303, the rendering module 117 proceeds to divide or otherwise categorize the movement into one or more portions based, for instance, on the gesture input used to initiate the movement. For example, if the input specifying the movement is a touch-based gesture (e.g., a swipe or flick), the rendering module 117 determines to correlate a first portion of the movement to a period of the touch-based gesture in which the touch-based gesture is tracked on the touch-enabled screen of the UE 101, and then determines to correlate a second portion of the movement to a kinetic follow-up after the period. In other words, the rendering module 117 defines at least two separate portions of a movement to render; a first portion corresponding to when the user's finger is in contact with the touch screen to register a movement or position. The second portion relates to a computed or inferred portion of the movement wherein the rendering module 117 calculates a kinetic follow-up to the movement indicated by the user's finger. The kinetic or inertial follow-up simulates an effect whereby an explicitly indicated movement (e.g., a swipe or flick) results in continued movement that continues for calculated or predetermined period of time. The kinetic follow-up provides feedback to the user and gives the perception that the movement has a realistic weight and is subject to normal physics resulting from the weight.

Next, the rendering module 117 determines respective rendering techniques to use for each determined portion of the movement (step 305). For example, the rendering module 117 determines a first rendering technique for at least a first portion of the movement and a second rendering technique for at least a second portion of the movement. Although various embodiments are discussed with respect to movements with two defined portions, it is contemplated that the movement may have any number of portions for which the rendering module 117 can define separate rendering techniques. In this example, the rendering module 117 can select rendering modules that prioritizes speed or responsive against smoothness. In one embodiment, the rendering techniques are determined based, at least in part, on an execution context or resource load of the UE 101.

Accordingly, the rendering module 117 determines a particular priority associated with any one or all of the portions of the movement (step 307). If the priority is for speed or responsiveness, the rendering module 117 determines or selects a rendering technique that, for instance, determines distances or gaps between frames of the movement based, at least in part, on speed (step 309). Speed, in this case, refers to the ability to keep up with the movement of the user's finger on the touch screen. For example, a display will appear responsive if the movement of the viewport can substantially keep up or match the movement of the user's finger. To prevent lagging behind the finger, the rendering module 117 may select a rendering technique that provides for skipping frames so that the frames can mirror the movement of the user's finger.

Conversely, if the priority is for smoothness, the rendering module 117 determines or selects a rendering technique that determines respective gaps between one or more rendered frames of the movement based, at least in part, on a predetermined maximum distance between the respective gaps (step 311). As described previously, the rendering module 117 may calculate a maximum distance between frames to achieve a desired level of smoothness. The rendering module 117 then uses this calculated distance to control how the frames and the corresponding gaps between them are prepared.

In step 313, the rendering module 117 prepares the frames and causes the frames to be rendered at the display of the UE 101. As part of the rendering process, the rendering module 117 may interact with the application 115, the service platform 107, the services 109a-109n, and/or the content providers 111a-111m to obtain the content for display (e.g., map data). By way of example, the interaction includes first determining to read the content (e.g., map data) from a local storage (e.g., local to the UE 101), a network storage, or a combination thereof. Then, the rendering module 117 determines to decode the content data. For example, content such as map data may often be compressed, encoded in a particular format, etc. As a result, the content often needs to be decoded into a format that can be rendered for display.

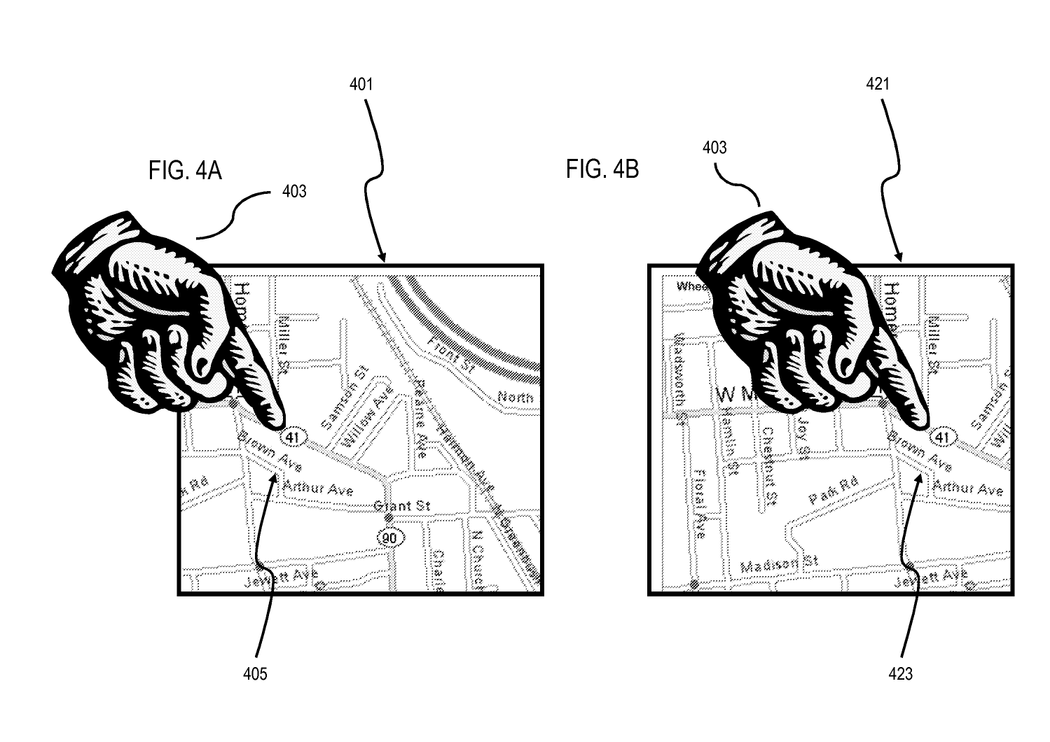

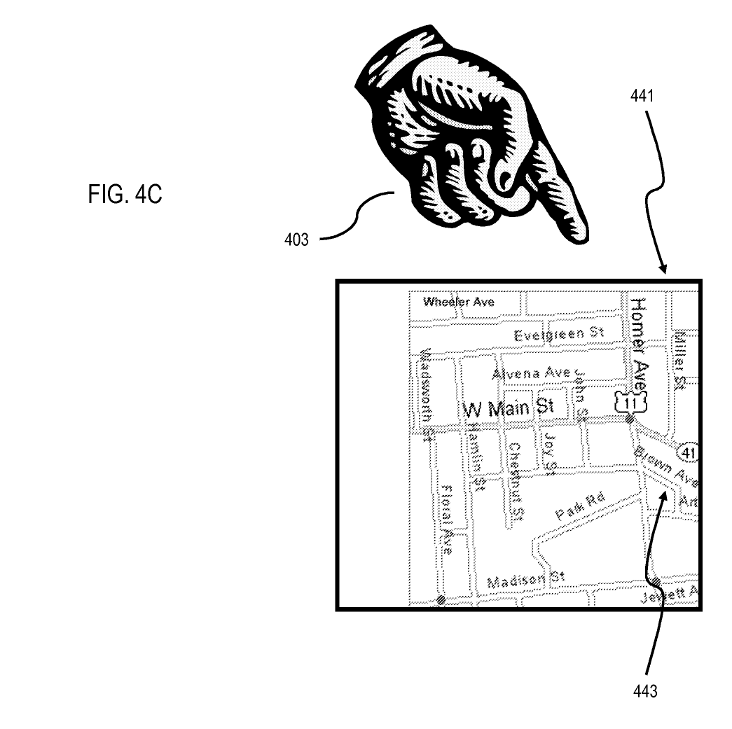

FIGS. 4A-4C are diagrams of user interfaces for utilizing the process of FIG. 3, according to various embodiments. FIG. 4A depicts a user interface consisting of a map display 401 rendered on a touch screen device. The user touches the display 401 with a hand 403. As shown, a finger of the hand 403 is touching the display at location 405 on Brown Avenue. In this example, the user makes a swiping motion from left to right to result in the user interface of FIG. 4B. In FIG. 4B, the display 401 of FIG. 4A has been rendered to move to the right in concert with the movement of the hand 403. The movement results in the display 421 in which the prior location 405 on Brown Avenue has been transposed to a new location 423 with respect to the display 421. In this phase of the movement, the hand 403 remains in contact with touch screen.

Accordingly, using the approach described herein, the rendering module 117 renders the map displays 401 and 421 in a way that prioritizes keeping up with the movement of the hand. In the examples of FIGS. 4A and 4B, the user's hand 403 moved quickly so that the rendering module 117 skipped several frames to ensure that frames can be prepared that produced a movement of the viewport over the map display that matches the movement of the finger. As shown, there is no lag in the frame update and the hand 403 in FIG. 4A remains in the same relative location with respect to the Brown Avenue as the hand 403 in FIG. 4B.

FIG. 4C depicts a second portion of the movement wherein the user's hand has completed the left to right swipe gesture and has been lifted from the touch screen. In this case, the rendering module 117 generates frames to animate movement based on the kinetic or inertial follow-up resulting from the initial gesture of FIGS. 4A and 4B. As shown, the location 443 of Brown Avenue with respect to the display 441 is closer to the right edge of the screen as the inertia of the initial gesture continues the movement. In this second portion or kinetic portion of the movement, the rendering module 117 no longer has to track the user's hand 403 and changes its rendering technique of the map display to prioritize smoothness. For example, subsequent frames with smaller gaps or distances between them are prepared and rendered. The combination of the initial rendering technique for responsiveness as performed in the case of FIGS. 4A and 4B and the secondary rendering technique for smoothness as performed in the case of FIG. 4C results in an improved perception of responsiveness and smoothness when compared to traditional rendering techniques, particularly when the rendering is performed on a resource constrained device.

The processes described herein for rendering a content display may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

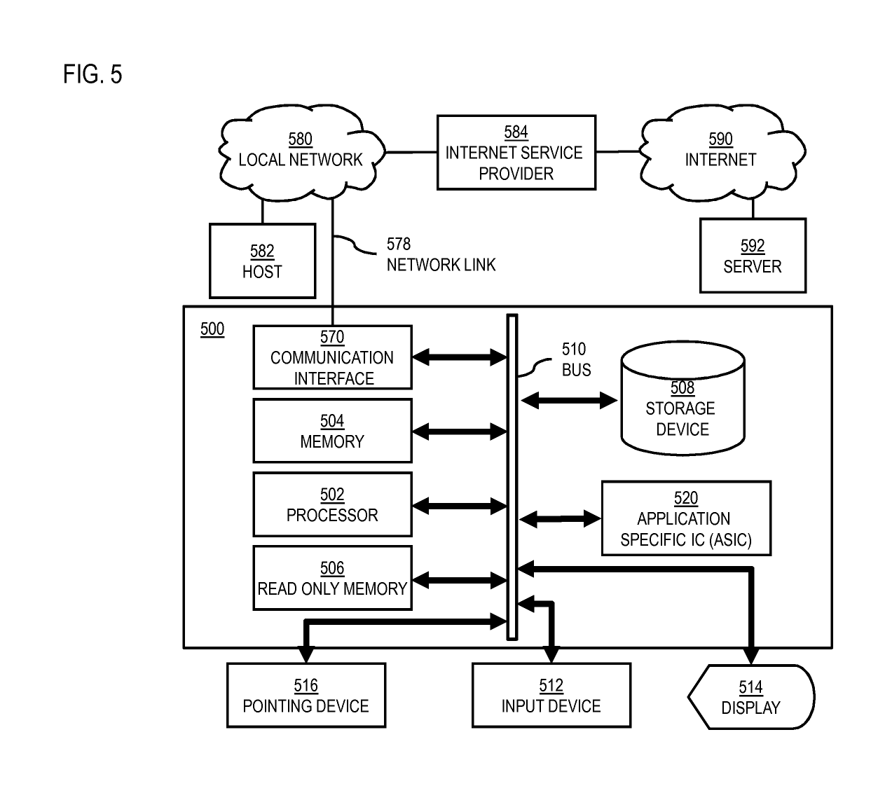

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to render a content display as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of rendering a content display.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to rendering a content display. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for rendering a content display. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for rendering a content display, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for rendering a content display.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to render a content display as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of rendering a content display.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to render a content display. The memory 605 also stores the data associated with or generated by the execution of the inventive steps.

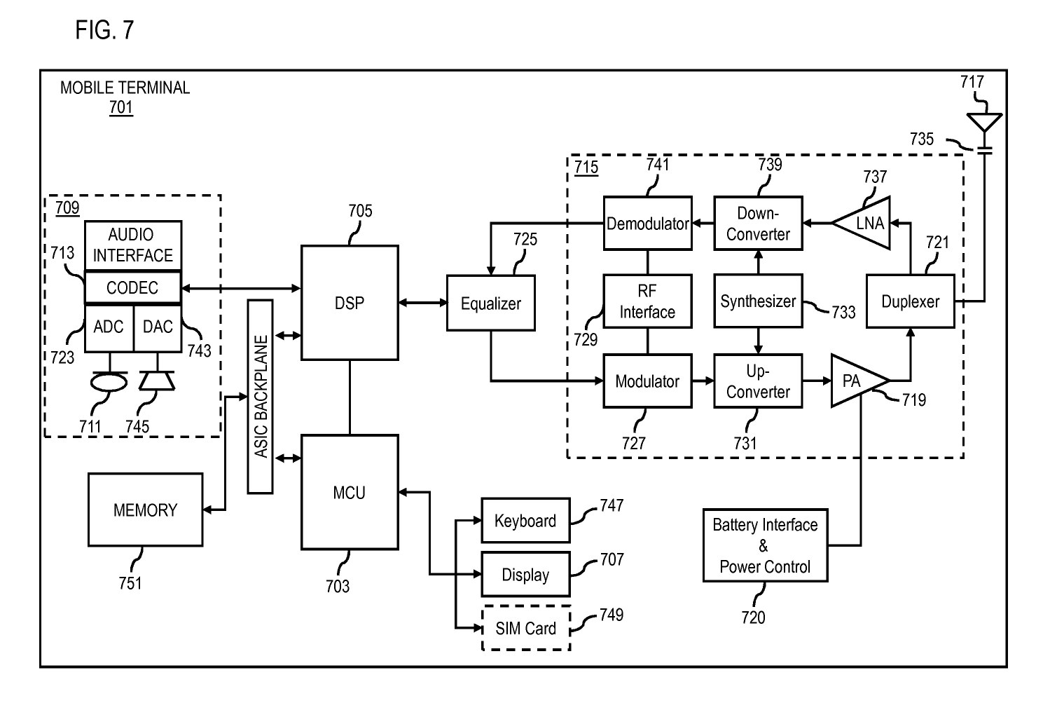

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of rendering a content display. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of rendering a content display. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to render a content display. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving an input for specifying a movement of a viewport over content rendered for display at a device;
determining a first rendering technique for at least a first portion of the movement; and
determining a second rendering technique for at least a second portion of the movement.

2. A method of claim 1, wherein the input is a touch-based gesture captured at a touch-enabled screen of the device, the method further comprising:
determining to correlate the first portion of the movement to a period of the touch-based gesture in which the touch-based gesture is tracked on the touch-enabled screen; and
determining to correlate the second portion of the movement to a kinetic follow-up after the period.

3. A method of claim 1, wherein the first rendering technique prioritizes a speed of the movement, and wherein the second rendering technique prioritizes a smoothness of the movement.

4. A method of claim 3, wherein prioritizing the speed of the movement comprises:
determining respective gaps between one or more rendered frames of the movement based, at least in part, on the speed.

5. A method of claim 3, wherein prioritizing the smoothness of the movement comprises:
determining respective gaps between one or more rendered frames of the movement based, at least in part, on a predetermined maximum distance between the respective gaps.

6. A method of claim 1, wherein the determination of the first rendering technique, the determination of the second rendering technique, or a combination thereof are based, at least in part, on an execution context of the device.

7. A method of claim 1, wherein the content includes map data, and wherein rendering the content for display comprises:
determining to read the map data from a local storage, a network storage, or a combination thereof;
determining to decode the map data; and
determining to generate one or more rendered frames based on, at least in part, on the map data.

8. An apparatus comprising:
at least one processor; and
at least one memory including computer program code for one or more programs,
the at least one memory and the computer program code configured to, with the at least one processor, cause the apparatus to perform at least the following,
receive an input for specifying a movement of a viewport over content rendered for display at a device;
determine a first rendering technique for at least a first portion of the movement; and
determine a second rendering technique for at least a second portion of the movement.

9. An apparatus of claim 8, wherein the input is a touch-based gesture captured at a touch-enabled screen of the device, and wherein the apparatus is further caused to:
determine to correlate the first portion of the movement to a period of the touch-based gesture in which the touch-based gesture is tracked on the touch-enabled screen; and
determine to correlate the second portion of the movement to a kinetic follow-up after the period.

10. An apparatus of claim 8, wherein the first rendering technique prioritizes a speed of the movement, and wherein the second rendering technique prioritizes a smoothness of the movement.

11. An apparatus of claim 10, wherein prioritizing the speed of the movement causes the apparatus to:
determine respective gaps between one or more rendered frames of the movement based, at least in part, on the speed.

12. An apparatus of claim 10, wherein prioritizing the smoothness of the movement causes the apparatus to:
determine respective gaps between one or more rendered frames of the movement based, at least in part, on a predetermined maximum distance between the respective gaps.

13. An apparatus of claim 8, wherein the determination of the first rendering technique, the determination of the second rendering technique, or a combination thereof are based, at least in part, on an execution context of the device.

14. An apparatus of claim 8, wherein the content includes map data, and wherein rendering the content for display causes the apparatus to:
determine to read the map data from a local storage, a network storage, or a combination thereof;
determine to decode the map data; and
determine to generate one or more rendered frames based on, at least in part, on the map data.

15. An apparatus of claim 8, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

16. A computer-readable storage medium carrying one or more sequences of one or more instructions which, when executed by one or more processors, cause an apparatus to at least perform the following steps:
receiving an input for specifying a movement of a viewport over content rendered for display at a device;
determining a first rendering technique for at least a first portion of the movement; and
determining a second rendering technique for at least a second portion of the movement.

17. A computer-readable storage medium of claim 16, wherein the input is a touch-based gesture captured at a touch-enabled screen of the device, and wherein the apparatus is caused to further perform:
determining to correlate the first portion of the movement to a period of the touch-based gesture in which the touch-based gesture is tracked on the touch-enabled screen; and
determining to correlate the second portion of the movement to a kinetic follow-up after the period.

18. A computer-readable storage medium of claim 16, wherein the first rendering technique prioritizes a speed of the movement, and wherein the second rendering technique prioritizes a smoothness of the movement.

19. A computer-readable storage medium of claim 18, wherein prioritizing the speed of the movement causes the apparatus to perform:
determining respective gaps between one or more rendered frames of the movement based, at least in part, on the speed.

20. A computer-readable storage medium of claim 18, wherein prioritizing the smoothness of the movement causes to apparatus to perform:
determining respective gaps between one or more rendered frames of the movement based, at least in part, on a predetermined maximum distance between the respective gaps.
